(19) United States
(12) Patent Application Publication
(10) Pub. No.: US 2020/0320110 A1
(43) Pub. Date: Oct. 8, 2020

(54) DOCUMENT PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Yusuke KAWANO, Kanagawa (JP)

(73) Assignee: FUJI XEROX CO., LTD., Tokyo (JP)

(21) Appl. No.: 16/731,051

(22) Filed: Dec. 31, 2019

(30) Foreign Application Priority Data
Apr. 5, 2019 (JP) 2019-072366

(51) Int. Cl. G06F 16/31; G06F 16/332; G06F 40/166; G06K 9/00

(52) U.S. Cl. CPC G06F 16/328; G06K 9/00456; G06F 40/166; G06F 16/3323

(57) ABSTRACT

A document processing apparatus includes a reception unit that, in a case where a first text string which is generated from a first range as a partial range of a content of a document and includes one or more text strings showing a feature of the document is present, receives specifying of a second range which is a range in which a second text string which includes one or more text strings at least partially different from the first text string is generated from the content, and a control unit that controls the reception of the specifying of the second range by the reception unit such that a data amount of the second text string generated from the second range is less than or equal to a data capacity of the second text string determined by a data amount of the first text string or less than or equal to a data capacity which is determined until the second range is specified after decision of the first range in the document.

### CROSS-REFERENCE TO RELATED APPLICATIONS

This application is based on and claims priority under 35 USC 119 from Japanese Patent Application No. 2019-072366 filed Apr. 5, 2019.

### BACKGROUND

### (i) Technical Field

The present invention relates to a document processing apparatus and a non-transitory computer readable medium storing a program.

### (ii) Related Art

In a case where a full text search function is provided in a document management system, index (that is, key) data is created in advance from the full text of a document of a search target stored in the document management system. The method of creating the index data from the full text of the document is referred to as full text indexing. In a case where the same function is provided in a cloud, the data capacity of the index data is directly connected to the cost of a storage. Thus, it is required to reduce the amount of the index data. Therefore, the index data is generally created from only a selected part of the document (for example, 100 KB from the head of the text). The method of creating the index data from a selected part of the document is referred to as partial indexing.

In addition, the following literatures in the related art are known as related art technologies related to indexing.

JP2005-267057A discloses a method for easily and quickly extracting text data in a case where the text data is extracted by designating a text region in the image data. This method is a text data extraction method of extracting the text data in the text region of the image data designated by a mouse, and includes a region setting unit that sets the range of the text region, a positional information acquisition unit that acquires any positional information designated by a single click of the mouse in image data, a region cutting unit that cuts the text region of the range set in the region setting unit based on the positional information, and a text data extraction unit that extracts the text data by performing an OCR process on the image data in the cut text region.

In a method disclosed in JP2006-164149A, when the index data is created or the index data is selected in a worksheet, an image part corresponding to the index data is generally displayed on an image viewer. Thus, an operator does not perform an operation of visually searching for a text information part corresponding to the index data from the image displayed on the image viewer.

### SUMMARY

In a case where a first text string that includes one or more text strings showing a feature of the document is generated from a first range that is the range of a part of the content of the document, and then, a second range that is a range in which a second text string which includes one or more text strings at least partially different from the first text string is generated is set, the data amount of one or more text strings generated from the second range may exceed a data capacity assigned to the document.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a document processing apparatus including a reception unit that, in a case where a first text string which is generated from a first range as a partial range of a content of a document and includes one or more text strings showing a feature of the document is present, receives specifying of a second range which is a range in which a second text string which includes one or more text strings at least partially different from the first text string is generated from the content, and a control unit that controls the reception of the specifying of the second range by the reception unit such that a data amount of the second text string generated from the second range is less than or equal to a data capacity of the second text string determined by a data amount of the first text string or less than or equal to a data capacity which is determined until the second range is specified after decision of the first range in the document.

### BRIEF DESCRIPTION OF THE DRAWINGS

Exemplary embodiment(s) of the present invention will be described in detail based on the following figures, wherein:

FIG. 1 is a diagram illustrating a configuration of a system of an exemplary embodiment;

FIG. 2 is a diagram illustrating a first half of a processing procedure of the system of the exemplary embodiment;

FIG. 3 is a diagram illustrating a second half of the processing procedure of the system of the exemplary embodiment;

FIG. 4 is a diagram illustrating an example of a document image that is provided to a user by an application server through an image viewer and includes a highlight display of an indexing range;

FIG. 5 is a diagram illustrating an example of an attribute image that is provided to the user by the application server through the image viewer and includes the highlight display of the indexing range;

FIG. 6 is a diagram illustrating the document image including a highlight display of a range added to the indexing range;

FIG. 7 is a diagram illustrating the document image including an alert display;

FIG. 8 is a diagram illustrating the document image including a highlight display of a range deleted from the indexing range;

FIG. 9 is a diagram illustrating another example of the second half of the processing procedure of the system of the exemplary embodiment;

FIG. 10 is a diagram illustrating the document image including a highlight display of an index in the original indexing range;

FIG. 11 is a diagram illustrating the document image including a highlight display of indexes in the original indexing range and the added range;

FIG. 12 is a diagram illustrating the document image including a highlight display of an index candidate outside the original indexing range;

FIG. 13 is a diagram illustrating the document image including a highlight display of an index outside the indexing range after update; and

FIG. 14 is a diagram illustrating still another example of the second half of the processing procedure of the system of the exemplary embodiment.

### DETAILED DESCRIPTION

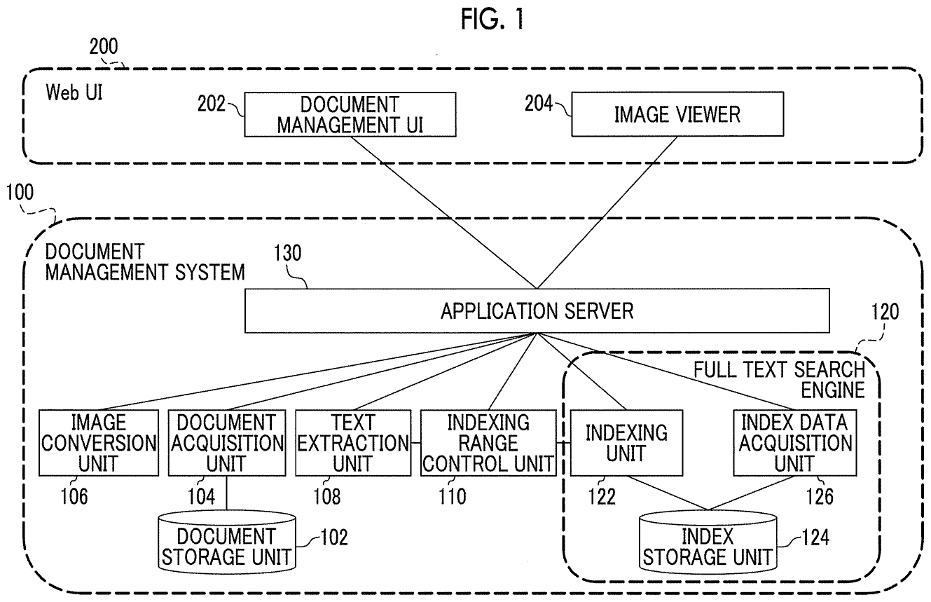

FIG. 1 illustrates a document management system 100 that is one example of a document processing apparatus according to an exemplary embodiment of the present invention, and a Web user interface (UI) 200 that is used in a case where the document management system 100 is used on a user side.

The document management system 100 is an information processing system that provides a document search service to a user. For example, the document management system 100 is built in a cloud.

In the document management system 100, a document storage unit 102 stores a file of each document (hereinafter, the file will be simply referred to as the “document”) as a search target. The file of each document includes a file body that is data of the content of the document, and attribute information of the document.

A document acquisition unit 104 acquires the file body and the attribute information of the document stored in the document storage unit 102 in accordance with an instruction from an application server 130. An image conversion unit 106 converts the file body and the attribute information of the document into image data. A text extraction unit 108 extracts text data included in the file body and the attribute information of the document.

An indexing range control unit 110 is a mechanism for controlling an indexing range to satisfy a condition that the data amount of index data generated from the document as an indexing target is less than or equal to a set upper limit data capacity. The indexing range control unit 110 passes the document as the indexing target to the text extraction unit 108 and acquires the text data extracted from the document by the text extraction unit 108. The indexing range control unit 110 has a function of selecting a part of the text data less than or equal to the upper limit data capacity in the indexing range and passing the part to an indexing unit 122. In addition, in a case where the user performs a changing operation for the indexing range, the indexing range control unit 110 performs control (for example, an alert display described later) such that the indexing range after the changing operation satisfies the above condition. The indexing range is a range as a target of an indexing process (in other words, an extraction range of an index) in the document.

A full text search engine 120 is a mechanism for executing a full text search of the document. The full text search engine 120 includes an indexing unit 122, an index storage unit 124, and an index data acquisition unit 126.

The indexing unit 122 generates the index data from the text data passed from the indexing range control unit 110. The index data is data consisting of one or more indexes, in other words, a collection of indexes. The index is a keyword or a key phrase included in the document. The indexing unit 122 extracts the index from the text data in the indexing range and outputs a collection of extracted indexes as the index data. A method of generating the index data from the text data by the indexing unit 122 is not particularly limited. Any method that exists or is to be developed may be used.

The index storage unit 124 stores the index data generated for the document by the indexing unit 122 in association with identification information of the document. In addition, in association with the identification information of the document, the index storage unit 124 stores range information representing the indexing range of the document. For example, the range information is information indicating a start position and an end position of the indexing range in each of the file content and the attribute information of the document. The range information may include the text data included in the indexing range. The indexing range for one document may be configured with plural partial ranges that are positionally separated from each other. In this case, the range information indicating the indexing range is a set of information indicating each partial range (for example, a start position and an end position of the partial range).

The index data acquisition unit 126 acquires the index data or the range information of the designated document or both of the index data and the range information from the index storage unit 124.

The application server 130 provides a UI for services such as registration and search of the document and checking and changing of the indexing range to the user. In addition, in response to an input received from the user through the UI, the application server 130 provides a process corresponding to the input of the user by controlling the document acquisition unit 104 to the full text search engine 120.

The Web UI 200 is a UI that uses World Wide Web (Web) technology and is provided to the user on a terminal such as a personal computer or a smartphone operated by the user. For example, the Web UI 200 is implemented by displaying a UI Web page provided by the application server 130 on a Web browser installed on the terminal. The use of Web technology in the UI of the document management system 100 is merely for illustrative purposes. UIs using other technologies may also be employed.

An image viewer 204 displays an image that represents the content and the attribute information of the document selected by the user. In addition, the image viewer 204 has a function of displaying the indexing range for the document of which the image is displayed, or receiving a changing operation for the indexing range.

A document management UI 202 is a core part of the Web UI 200 for the document management system 100 and provides various screens for document management and receives operations for the screens from the user. For example, the screens provided by the document management UI 202 include a screen showing a configuration of a folder group of the document storage unit 102, a screen of a document list in each folder, and a screen of a document list of a search result. In addition, the document management UI 202 receives a selection of the document and an input of an operation instruction for the selected document from the user on the screen of the document list. For example, the document management UI 202 displays a menu of selectable operation items for the document on the screen and receives a selection of the operation item on the menu from the user. For example, the selectable operation items include download of the document, display of the attribute, and setting of the indexing range. In a case where the user selects the setting of the indexing range as an operation for a certain document, the image viewer 204 displays a screen representing the image of the document and the indexing range.

In a case where the document is registered in the document management system 100 from the user, the indexing range control unit 110 automatically sets the indexing range for the document. In this setting, the indexing range is set such that a data amount related to the indexing range is less than or equal to a threshold. The “data amount related to the indexing range” may be the data amount of the text string included in the indexing range or may be the data amount of the index data generated by the indexing unit 122 from the text string included in the indexing range.

For example, as in the related art, the indexing range control unit 110 may automatically set the indexing range such that the data amount of the text string included in the indexing range is less than or equal to a predetermined fixed threshold.

Even in a case where any of the data amount of the text string in the indexing range or the data amount of the index data is restricted using the threshold, the threshold may be fixed, or the threshold may be dynamically set depending on an amount related to a document group currently stored in the document storage unit 102.

For example, the threshold may be determined based on the total amount of the index data of the document group currently stored in the document storage unit 102. For example, the threshold is set in accordance with a function or a rule such that as the total amount of the index data is increased, the threshold is decreased. From another viewpoint, an upper limit may be set on a storage capacity prepared for the index data, and the threshold may be set such that as the vacant amount of the upper limit storage capacity (that is, the remaining amount after the total amount of the current index data is subtracted from the upper limit) is decreased, the threshold is decreased.

In addition, for example, the threshold may be determined based on the number of documents stored in the document storage unit 102 or the total amount of data of the document group. For example, the threshold may be determined based on a function or a rule such that as the number of documents in the document storage unit 102 is increased, the threshold is decreased. In addition, the threshold may be determined based on a function or a rule such that as the total amount of data of the document group in the document storage unit 102 is increased, the threshold is decreased. From another viewpoint, an upper limit may be set on the storage capacity of the document storage unit 102, and the threshold may be set such that as the vacant amount of the upper limit storage capacity (that is, the remaining amount after the total amount of data of the current document group is subtracted from the upper limit) is decreased, the threshold is decreased.

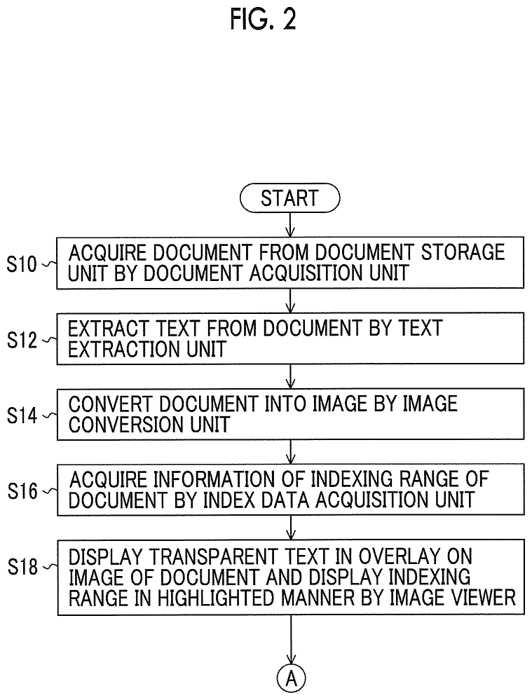

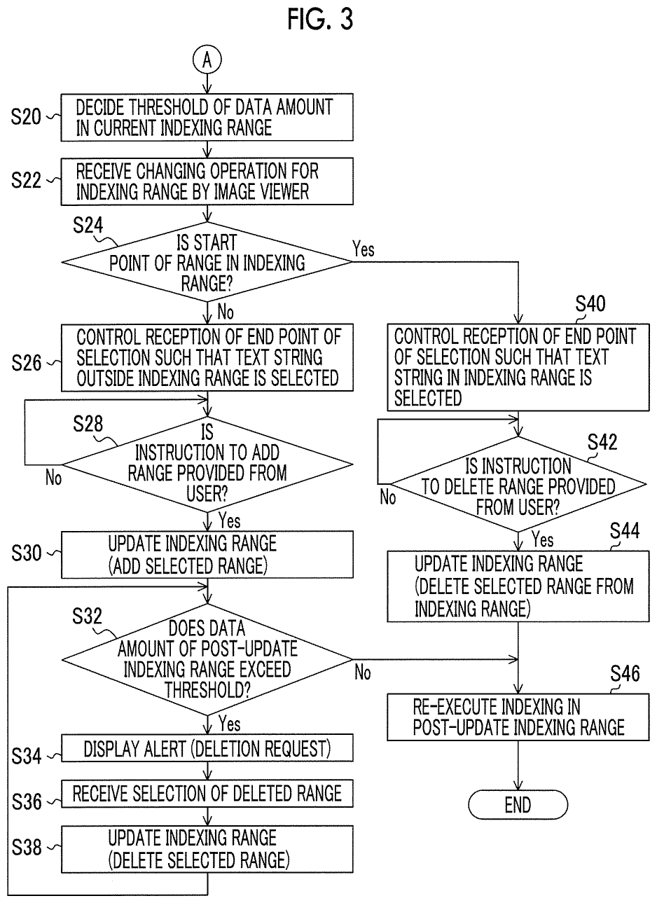

In the example in FIG. 2 and FIG. 3, a case where the threshold is set on the data amount of the text string included in the indexing range is described for simplification of description.

Next, the indexing unit 122 generates the index data from the text data in the indexing range and stores the index data in the index storage unit 124 in association with the identification information of the document. At this point, the indexing range control unit 110 automatically sets the indexing range in accordance with a predetermined algorithm. However, the automatically set indexing range may not be appropriate. That is, the index data generated from the indexing range automatically set for the document may not include an index that well represents the feature of the document. In order to deal with such a case, a UI for checking and changing the indexing range of the document is provided to the user in the present exemplary embodiment.

For example, the user may desire to search for a document that the user is well aware of and that is registered in the document management system 100 (for example, a document registered by the user), and input a specific keyword included in the document, but the document may not be found in the search result. In this case, the user searches for the document by traversing the folder hierarchy of the document management system 100 or performing search using another keyword. At this point, the user considers why the document may not be searched using the initially input keyword that is to be included in the document. Then, the user perceives a possibility that the keyword is not included in the index data generated from the indexing range automatically set by the document management system 100, and checks whether or not the indexing range is appropriate using the UI of the present exemplary embodiment and changes the indexing range as necessary.

One example of a process that is executed by the document management system 100 in order for the user to check and change the indexing range will be described with reference to flowcharts in FIG. 2 and FIG. 3.

For example, this process is started in a case where the user selects a certain document and selects the operation item of the “setting of the indexing range” in the document list that is provided from the application server 130 and is displayed on the screen of the terminal of the user by the document management UI 202.

The document management UI 202 transmits a processing request including the identification information of the document selected by the user and information indicating the operation item of the “setting of the indexing range” selected by the user to the document management system 100 through a network. The application server 130 of the document management system 100 receiving the processing request executes information processing corresponding to the processing request by controlling the document acquisition unit 104 to the index data acquisition unit 126.

In this process, as illustrated in FIG. 2, first, the document acquisition unit 104 acquires the document selected by the user from the document storage unit 102 (S10). Next, the text extraction unit 108 extracts the text data from the document (S12). At this point, the text data is extracted from not only the file main body but also the attribute information of the document. The image conversion unit 106 generates the image data indicating an image of the file main body and the attribute information of the document (S14). The index data acquisition unit 126 acquires the range information representing the indexing range of the document from the index storage unit 124 (S16). The application server 130 receives the text data extracted by the text extraction unit 108, the image data generated by the image conversion unit 106, and the range information acquired by the index data acquisition unit 126. From the data and the information, the application server 130 generates data (for example, data in the HTML format) of a UI screen for changing the indexing range. For example, this data is data in which the text data that is made transparent is overlaid on the image of the document by aligning the position of each text to match, and the indexing range indicated by the range information is highlighted in the form of a highlight display. The application server 130 returns this data to the Web UI 200 as a response to the processing request. At this point, in a case where the indexing range is set in only the file main body of the document, the application server 130 may respond to the Web UI 200 with only the data for the file main body. In a case where the indexing range is also set in the attribute information of the document, the application server 130 may respond to the Web UI 200 with the data for both of the file main body and the attribute information. In the Web UI 200 receiving the data, the image viewer 204 displays a document image indicated by the data on the screen of the terminal of the user (S18).

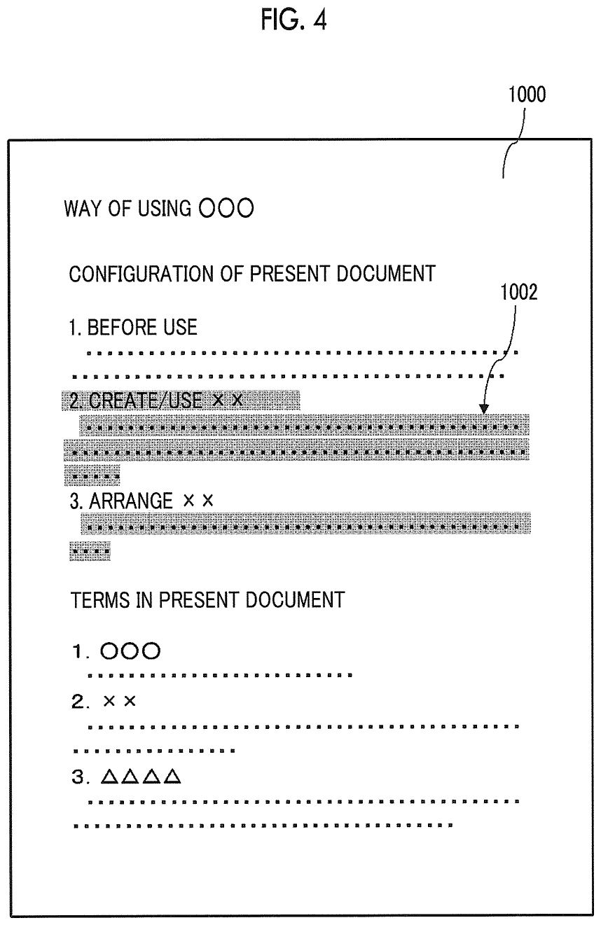

FIG. 4 illustrates a document image 1000 displayed on the screen of the terminal at this point. The document image 1000 is an image in which a part corresponding to the indexing range is displayed in a highlighted manner by a highlight display 1002 in the image representing the content of the document.

While illustration is not provided, in a case where the indexing range is set to be divided into in plural partial ranges that are separated from each other, the plural partial ranges may be collectively displayed as one range. For example, each of the plural partial ranges is extracted, and an image in which the partial ranges are arranged in order of appearing position in the document may be displayed. Accordingly, the plural partial ranges that may not be browsed by the user in a normal display of the document image 1000 are provided to the user in a browsable state.

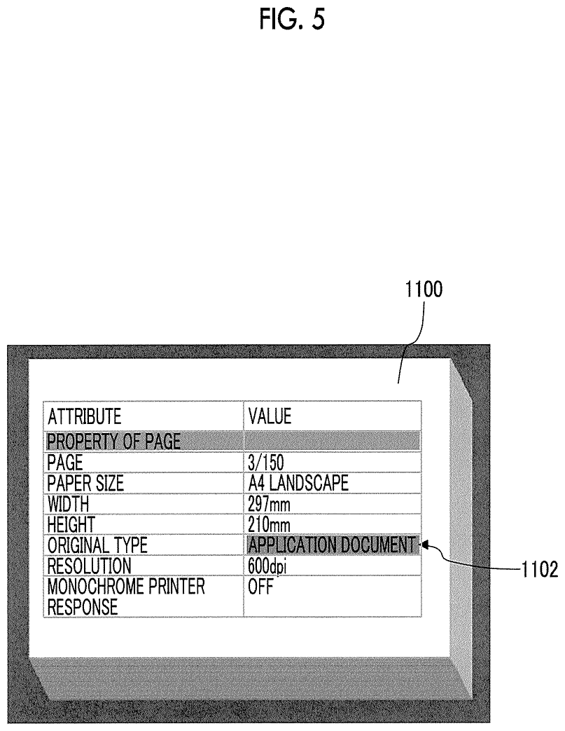

In a case where the indexing range is also set in the attribute information of the document, for example, an attribute image 1100 illustrated in FIG. 5 is displayed on the screen of the terminal. In this example, apart corresponding to the indexing range in the attribute image 1100 is highlighted by a highlight display 1102.

The user sees the parts highlighted by the highlight displays 1002 and 1012 in the document image 1000 and the attribute image 1100, and checks whether or not the indexing range is appropriate. For example, in a case where the user perceives that the index that the user considers necessary is not included in the indexing range, the user changes the indexing range using a UI provided by the image viewer 204.

In a case where the operation of the “setting of the indexing range” is selected, as illustrated in FIG. 3, the application server 130 decides a threshold of a data amount (that is, an allowed data amount; an upper limit value) that is to be currently applied to the indexing range of the document (S20). For example, this threshold may be the same as the threshold in a case where the indexing range control unit 110 automatically sets the indexing range. That is, a predetermined fixed threshold may be used, or a threshold that is decided depending on the amount related to the document group currently stored in the document storage unit 102 may be used. For example, the latter threshold may be decided to be decreased as the total amount of the index data of the document group, the number of document groups, or the total amount of data of the document group in the document storage unit 102 is increased. In addition, this threshold may be decided based on the amount (hereinafter, referred to as a first data amount) of the index data of the document stored in the index storage unit 124. For example, in a case where it is determined that there is a free space in a storage of the document management system 100 considering the amount related to the document group currently stored in the document storage unit 102, the first data amount is employed as the threshold. In a case where it is determined that there is no free space, an amount smaller than the first data amount is set as the threshold. As is apparent from the description thus far, the threshold decided in S20 may be different from the threshold when the indexing range control unit 110 automatically sets the original indexing range. The application server 130 notifies the image viewer 204 of the threshold decided in S20.

The image viewer 204 receives a changing operation for the indexing range from the user on the displayed document image 1000 and the attribute image 1100 (S22). The changing operation for the indexing range is performed by a range designation operation by a pointing device such as a mouse or a touch on a touch panel screen.

For example, the image viewer 204 is in a non-range designation mode when the document image 1000 and the like are initially displayed. In the non-range designation mode, in a case where a position (for example, a position in a range in which the transparent text is overlaid) selectable in the document image 1000 and the like is selected by the pointing device or the like, the image viewer 204 transitions to a range designation mode and recognizes the position as a start point of a designated range. Next, the image viewer 204 waits until the position of the end point of the designated range is selected by the pointing device or the like. In a case where the position of the end point is selected, the image viewer recognizes the range of the start point to the end point as a range designated by the user and returns to the non-range designation mode. By performing the range designation operation, the user designates a range added or deleted with respect to the original indexing range (that is, the indexing range read from the index storage unit 124 in step S16).

In a case where the start of the changing operation for the indexing range (that is, the range designation operation) is detected, a determination as to whether or not the start point of the range designation is positioned in the original indexing range is performed (S24).

In a case where the determination result in S24 is No, that is, in a case where a position outside the original indexing range is designated as the start point of the range designation, the designation operation designates a range added to the original indexing range. In this case, the image viewer 204 receives a designation of the endpoint of the range designation. At this point, a position outside the original indexing range is received as the end point, and a position in the original indexing range is not received as the endpoint (S26). Accordingly, a range having a part in overlap with the original indexing range is prevented from being designated as a range added to the indexing range.

In a case where the user selects a position outside the original indexing range as the end point by the pointing device or the like, the image viewer 204 makes an inquiry to the user about whether or not to add the designated range defined by the end point and the previously designated start point to the indexing range (S28). At this point, the designated range is being displayed in a highlighted manner in a different display form from the original indexing range. The user inputs a positive or negative response with respect to the inquiry. In a case where a negative input is provided, the image viewer 204 waits until the user re-designates the end point of the designated range. In a case where a positive response is provided from the user with respect to the inquiry (the determination result in S28 is Yes), the image viewer 204 updates the indexing range by adding a designated range that is designated at this time to the original indexing range (S30). This update is a temporary update inside the image viewer 204, and the document management system 100 side is not notified of the update result yet.

The image viewer 204 obtains the data amount of the text string in the post-update indexing range in S30 and determines whether or not the data amount is greater than the threshold decided in S20 (S32). In a case where the determination result in S32 is Yes, that is, in a case where the data amount of the text string in the post-update indexing range is greater than the threshold, the data amount of the index data generated from the indexing range is likely to be greater than the data amount of the index data in a case where the data amount of the text string in the indexing range is less than or equal to the threshold. In a case where the amount of the index data is increased, a large capacity of the storage for the index data in the document management system 100 is consumed, and a cost for the storage is increased. Therefore, in this example, the data amount of the post-update indexing range is not allowed to exceed the threshold. The image viewer 204 performs an alert display that indicates that the indexing range exceeds the data amount (S34). This alert display includes a message that explicitly or implicitly requests a partial range to be deleted from the indexing range. The alert display is one example of a display of a deletion request for requesting designation of the deleted range. In response to the alert display, the user selects, that is, designates, the deleted range on the document image 1000 and the like displayed on the screen, and the image viewer 204 receives the selection of the deleted range (S36). The selection of the deleted range may be performed in the same manner as the range designation in S22 and the like. The image viewer 204 further updates the indexing range by deleting the selected deleted range from the current indexing range (that is, at this point, the indexing range obtained by adding the range selected by the user to the original indexing range in S30) (S38). Then, a return is made to S32, and a determination as to whether or not the data amount of the post-update indexing range is greater than the threshold is performed. The loop of S32 to S38 thus far is repeated until a determination result of No is obtained in S32.

In a case where the determination result in S32 is No, that is, the data amount of the post-update indexing range is less than or equal to the threshold, the indexing range is acceptable. In this case, the image viewer 204 notifies the document management system 100 of the range information representing the indexing range. The application server 130 of the document management system 100 receiving the notification causes the indexing unit 122 to re-execute the indexing of the document in the indexing range represented by the range information (S46). Then, the indexing unit 122 re-executes the indexing process on a text string in the indexing range of the document as a target. Accordingly, the index is extracted from the post-update indexing range that includes the range added by the user. It is considered that the user designates the added range to be a range that includes the keyword desired to be extracted as the index. Thus, in S46, the keyword is extracted as the index with a high probability. The indexing unit 122 deletes the index data of the document stored in the index storage unit 124 and instead, stores the index data generated in S46 in the index storage unit 124 as the index data of the document.

While the indexing is re-executed on the entire post-update indexing range including the added range as a target, the indexing is merely for illustrative purposes. Instead, the indexing unit 122 may perform the indexing process on only the added range as a target and add an index newly extracted by this process to the original index data stored in the index storage unit 124. In this case, in a case where a part of the newly extracted index is included in the original index data, the part does not need to be added to the original index data.

In a case where the determination result in S24 is Yes, that is, a position in the original indexing range is designated as the start point of the range designation, the designation operation designates a range deleted from the original indexing range. In this case, the image viewer 204 receives a designation of the end point of the range designation. At this point, a position in the original indexing range is received as the end point, and a position outside the original indexing range is not received as the end point (S40).

In a case where the user selects a position in the original indexing range as the end point by the pointing device or the like, the image viewer 204 makes an inquiry to the user about whether or not to delete the designated range defined by the end point and the previously designated start point from the indexing range (S42). At this point, the designated range is being displayed in a highlighted manner in a different display form from the original indexing range and the ranges added in S26 and S28. The user inputs a positive or negative response with respect to the inquiry. In a case where a negative input is provided, the image viewer 204 waits until the user re-designates the end point of the designated range. In a case where a positive response is provided from the user with respect to the inquiry (the determination result in S42 is Yes), the image viewer 204 updates the indexing range by deleting a designated range that is designated at this time from the original indexing range (S44). The image viewer 204 notifies the document management system 100 of the range information representing the post-update indexing range. The application server 130 of the document management system 100 receiving the notification causes the indexing unit 122 to re-execute the indexing of the document in the indexing range represented by the range information (S46). Then, the indexing unit 122 re-executes the indexing process on a text string in the post-update indexing range of the document as a target. The indexing unit 122 deletes the index data of the document stored in the index storage unit 124 and instead, stores the index data generated in S46 in the index storage unit 124 as the index data of the document.

While the indexing is re-executed on the entire post-update indexing range from which the designated range is deleted as a target, the indexing is merely for illustrative purposes. Instead, the index included in only the designated range may be deleted from the original index data stored in the index storage unit 124.

In the procedure in FIG. 3, in a case where the data amount of the post-update indexing range exceeds the threshold in S32, the alert display (S34) is performed, and the user is requested to designate the deleted range. Instead, the designation of the added range that is the cause of the exceeding may be canceled. In a case where the cancellation is performed, the user designates the added range again, or designates the deleted range and then, designates the added range again.

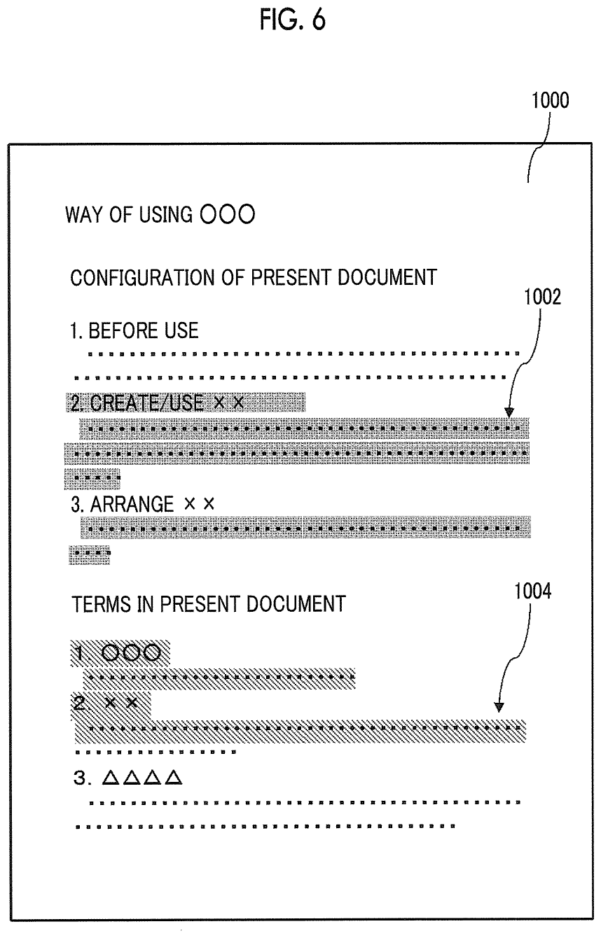

FIG. 6 illustrates the document image 1000 displayed by the image viewer 204 when the designation of the range added to the indexing range is received from the user in S26 to S28. As illustrated, the range designated as the added range is illustrated by a highlight display 1004 of a different display form (for example, a different color) from the highlight display 1002 of the original indexing range read from the index storage unit 124.

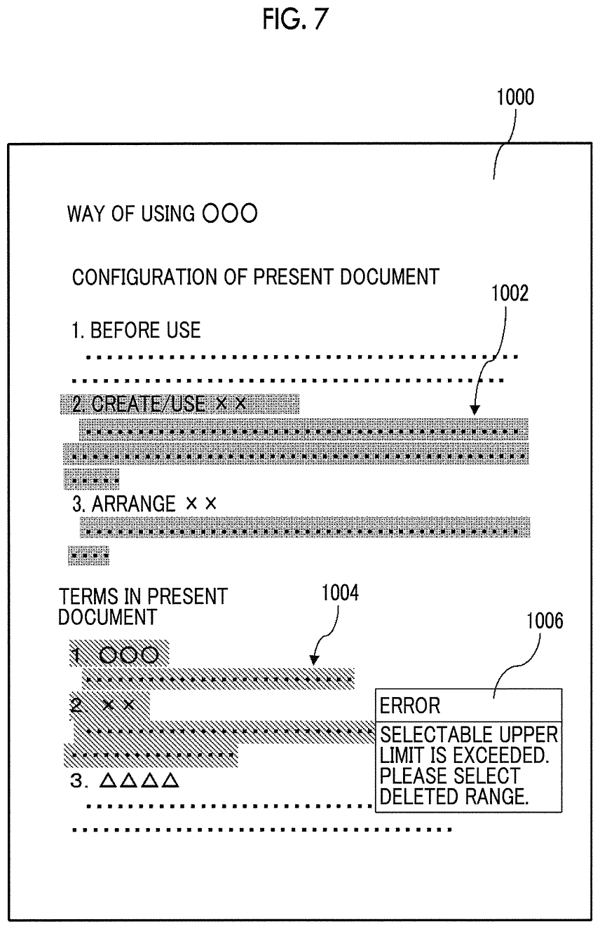

FIG. 7 illustrates an example of an alert display 1006 displayed in S34. In this example, in a case where the data amount of the indexing range exceeds the threshold as a result of adding the added range (that is, the range in the highlight display 1004) designated by the user on the document image 1000 displayed by the image viewer 204, the alert display 1006 is displayed. The alert display 1006 includes a message indicating that the selected range exceeds the upper limit, and the deleted range needs to be designated.

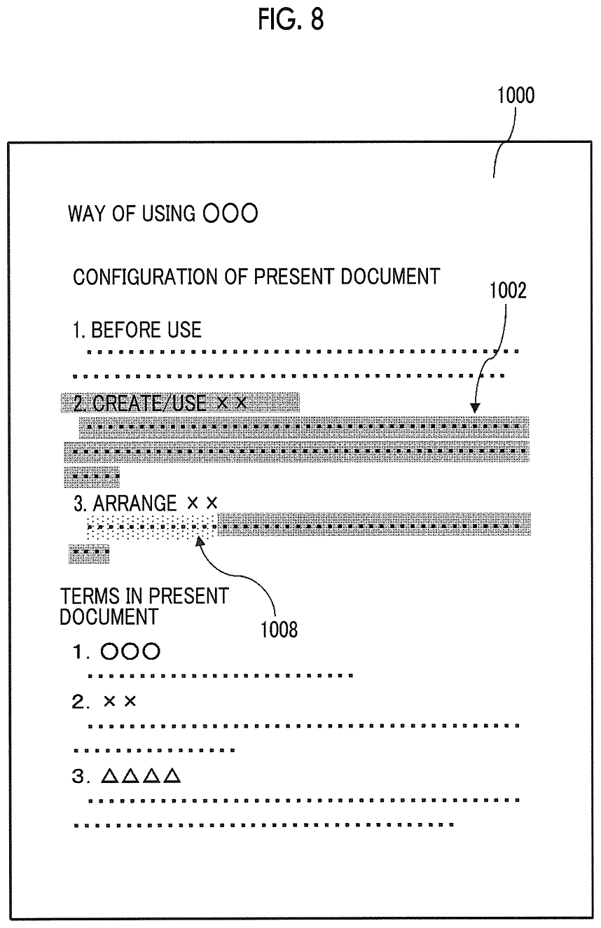

FIG. 8 illustrates the document image 1000 displayed by the image viewer 204 when the designation of the range deleted from the indexing range is received in S40 to S42. As illustrated, the range designated as the deleted range is shown by a highlight display 1008 of a different display form (for example, a different color) from any of the highlight display 1002 of the original indexing range read from the index storage unit 124 and the highlight display of the added range illustrated in FIG. 6.

The entire document may be automatically set as the indexing range as in a case where the size of the document is small. In a case where the indexing range is the entire document, the image viewer 204 may not receive the designation of the range added to the indexing range and receive only the designation of the deleted range.

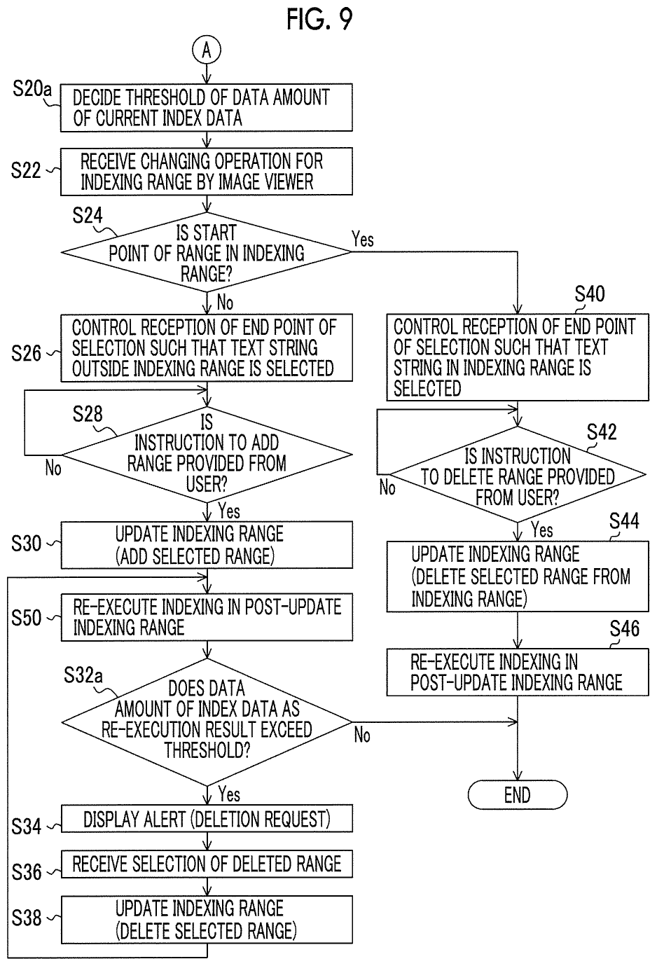

The procedure illustrated in FIG. 3 is an example of a case where the threshold of the data amount of the text string in the indexing range is used as a threshold defining the upper limit in a case where the indexing range is added. An example of a processing procedure in a case where the threshold of the data amount of the index data generated from the text string in the indexing range is used as the threshold is illustrated in FIG. 9. The procedure in FIG. 9 is executed after the procedure in FIG. 2. In the procedure in FIG. 9, steps representing the same process as the procedure in FIG. 3 are designated by the identical reference signs.

The procedure in FIG. 9 is different from the procedure in FIG. 3 in S20a, S50, and S32a.

In S20a, the application server 130 decides the threshold (that is, the upper limit value) of the data amount of the current index data of the document. For example, this threshold may be the same as the threshold in a case where the indexing range control unit 110 automatically sets the indexing range. That is, a predetermined fixed threshold may be used, or a threshold that is decided depending on the amount related to the document group currently stored in the document storage unit 102 may be used. For example, the latter threshold may be decided to be decreased as the total amount of the index data of the document group, the number of document groups, or the total amount of data of the document group in the document storage unit 102 is increased. In addition, this threshold may be decided based on the amount of the index data of the document stored in the index storage unit 124. The application server 130 notifies the image viewer 204 of the threshold decided in S20a. The processes of S22 to S30 and S40 to S46 are the same as the processes of the example in FIG. 3.

After S30, the image viewer 204 notifies the document management system 100 of the post-update indexing range. In the document management system 100 receiving the notification, the application server 130 causes the indexing unit 122 to re-execute the indexing in the post-update indexing range (S50). While the term “post-update indexing range” is used for convenience, the term is merely used in a temporary sense. At this time, the range information of the indexing range of the document stored in the index storage unit 124 is not updated yet (in other words, the update of the indexing range is not confirmed).

Next, the application server 130 determines whether or not the data amount of the index data generated from the post-update indexing range by the indexing unit 122 in S50 is greater than the threshold determined in S20a (S32a).

In a case where the determination result in S32a is No, the application server 130 employs the index data and the range information of the indexing range. That is, the existing index data and range information of the document stored in the index storage unit 124 are deleted, and instead, the employed index data and range information are stored.

In a case where the determination result in S32a is Yes, the application server 130 returns error information indicating that the post-update indexing range exceeds the threshold to the image viewer 204. Then, the image viewer 204 performs the alert display (S34), receives the selection of the deleted range from the user (S36), further updates the indexing range depending on the selected deleted range (S38), and returns to the process of S50.

As illustrated in FIG. 9, even in the method of determining the threshold with respect to the data amount of the index data, the same process as FIG. 3 may be performed.

In the procedure in FIG. 9, in a case where the determination result in S32a is No (that is, the data amount of the index data is less than or equal to the threshold), the post-update indexing range is immediately employed. However, the procedure is merely for illustrative purposes. Instead, in a case where the difference between the data amount and the threshold is sufficiently large (for example, a difference greater than or equal to a predetermined amount), the application server 130 may present a hint display showing that a range may be further added to the user through the image viewer 204. The user responds to the hint display by further adding a range or not adding a range anymore.

### Various Modification Examples

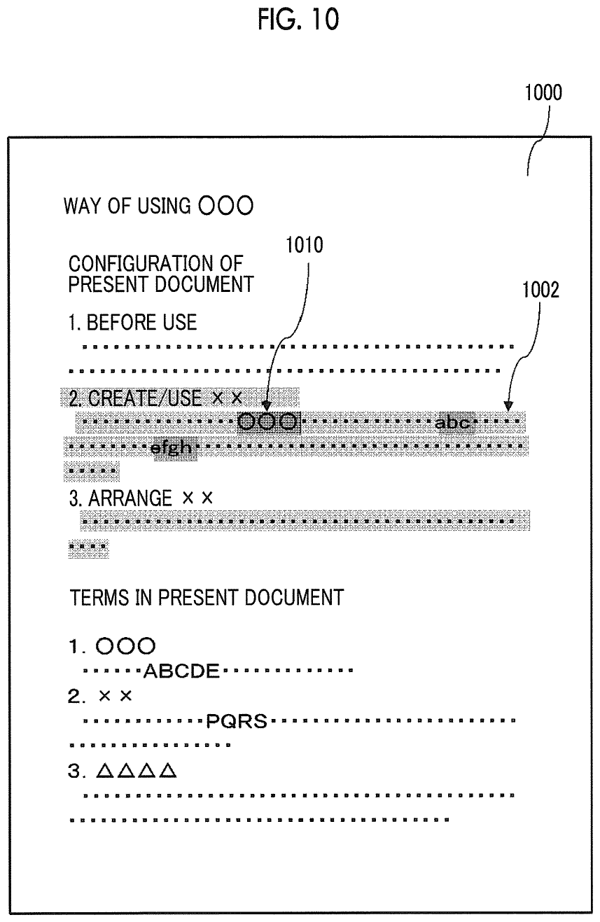

In S18 of the procedure in FIG. 2, as illustrated in FIG. 4, the image viewer 204 displays the document image 1000 in which the indexing range is highlighted by the highlight display 1002. As a modification example, in S18, the image viewer 204 may display the document image 1000 in which each index in the indexing range is shown by a highlight display 1010 in addition to the highlight display 1002 of the indexing range (refer to FIG. 10). The display form of the highlight display 1010 is different from any of the highlight display 1002 of the indexing range, the highlight display 1004 of the added range illustrated in FIG. 6, and the highlight display 1008 of the deleted range illustrated in FIG. 8.

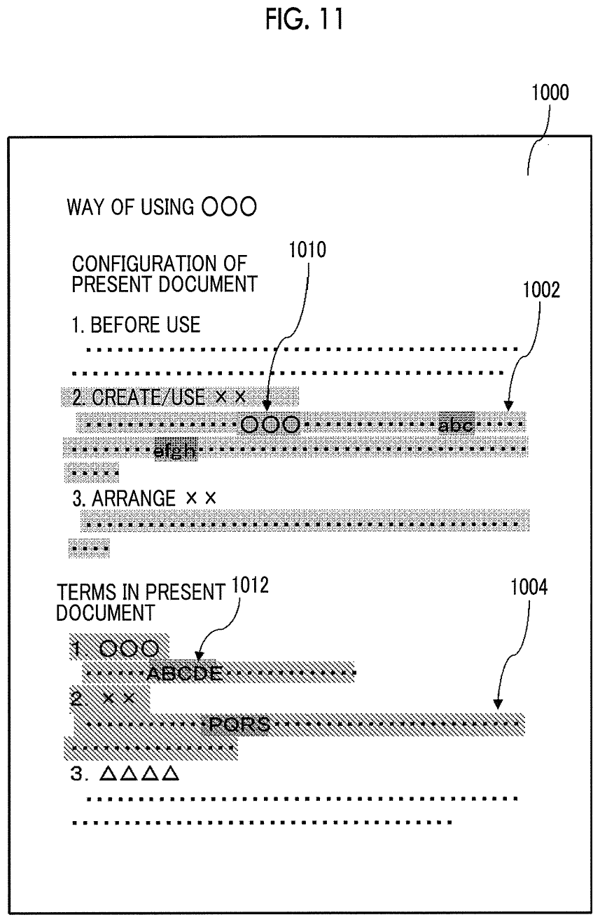

In the same manner, as illustrated in FIG. 11, after the user designates the added range in S26 to S30 in FIG. 9, the image viewer 204 may show the index in the original indexing range by the highlight display 1010 and show the index in the added range by a highlight display 1012. Words shown by the highlight display 1012 in the added range may be only words that are not included in the index data extracted from the original indexing range among words and the like selected as the index in the range. Accordingly, the index newly selected from the added range is perceptibly presented to the user.

In addition, while illustration is not provided, in a case where the same index is included in both of the original indexing range and the added range, the same index may be displayed in a highlighted manner in a display form distinguishable from the index included in only one of the original indexing range and the added range. For example, this display is performed in the document image 1000 in a case where the alert display (refer to S34 in FIG. 3 and FIG. 7) is performed. The user perceives the same index included in both ranges by the highlight display. Thus, an action such as performing an operation of deleting a range including the same index in the added range may be performed. For example, in a case where a method of storing the text data of the indexing range in the index storage unit 124 in association with the range information representing the indexing range is employed, the indexing range is reduced, and accordingly, the data amount in the index storage unit 124 is reduced.

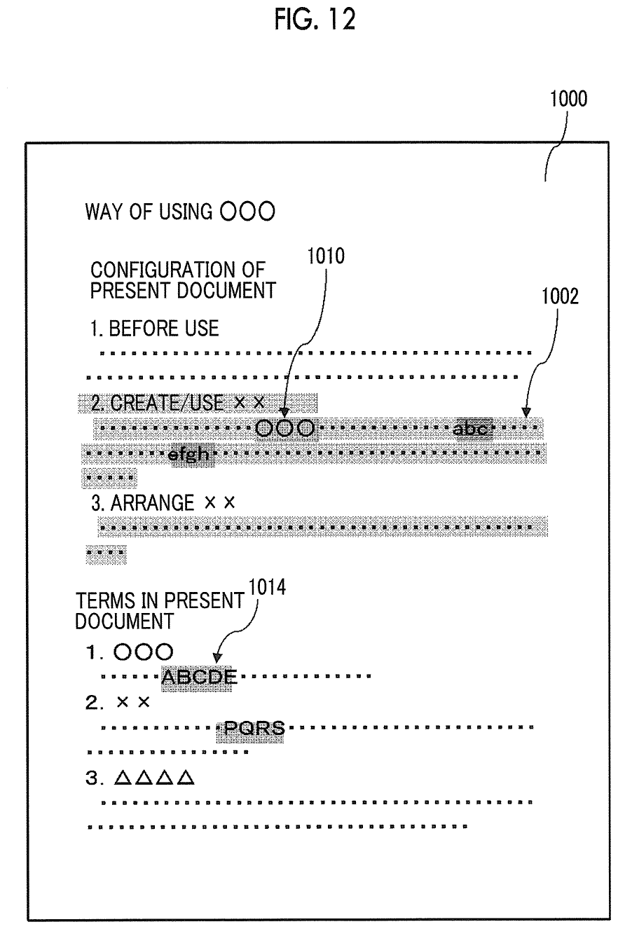

In addition, as illustrated in FIG. 12, the image viewer 204 may show an index candidate outside the indexing range by a highlight display 1014 in addition to the highlight display 1010 of each index in the indexing range in S18. The index candidate is a text string as a candidate of the index extracted by the indexing unit 122 from the text string outside the indexing range in the document. In a case where the user selects the operation of the “setting of the indexing range”, the application server 130 causes the indexing unit 122 to execute the indexing process on the text string outside the indexing range in the document as a target. In this process, for each word or the like included in the text string outside the indexing range, the indexing unit 122 calculates an index appropriateness degree (in other words, a degree to which the feature of the document is represented) in the same manner as the normal indexing process. The indexing unit 122 extracts a word or the like of which the appropriateness degree is greater than or equal to a threshold as the index candidate. A word or the like that is already included as the index in the index data generated from the indexing range may not be extracted as the index candidate even in a case where the appropriateness degree of the word or the like is greater than or equal to the threshold. The application server 130 includes information for specifying the index candidate in data of the document image 1000 transmitted to the image viewer 204. Based on this information, the image viewer 204 performs the highlight display 1014 of the index candidate. The display form of the highlight display 1014 of the index candidate is distinguishable from any of the highlight display 1002 of the indexing range, the highlight display 1004 of the added range, the highlight display 1008 of the deleted range, and the highlight display 1012 of the index in the indexing range.

As illustrated in FIG. 12, by explicitly showing the index candidate outside the indexing range by the highlight display 1014, information that is a determination basis of the range added to the indexing range is provided to the user.

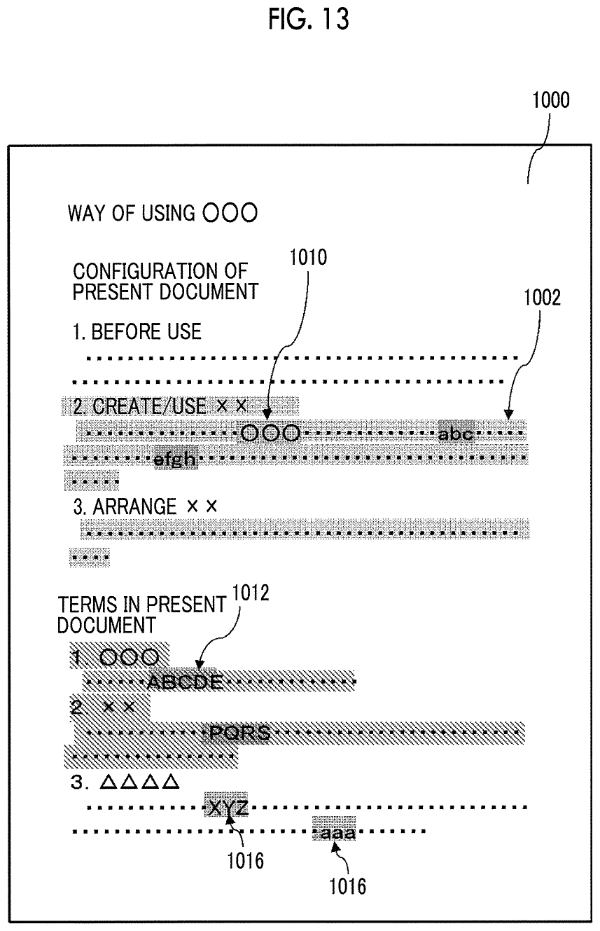

In the same manner as the example in FIG. 12, after the user selects the range added to the indexing range, the index candidate may be obtained from the outside of the post-update indexing range on which the addition is reflected, and the obtained index candidate may be displayed in a highlighted manner. In the example illustrated in FIG. 13, the index candidate outside the post-update indexing range into which both of the original indexing range and the added range are combined is shown by a highlight display 1016 in addition to the highlight display 1010 and the highlight display 1012 showing the indexes in the original indexing range and the added range.

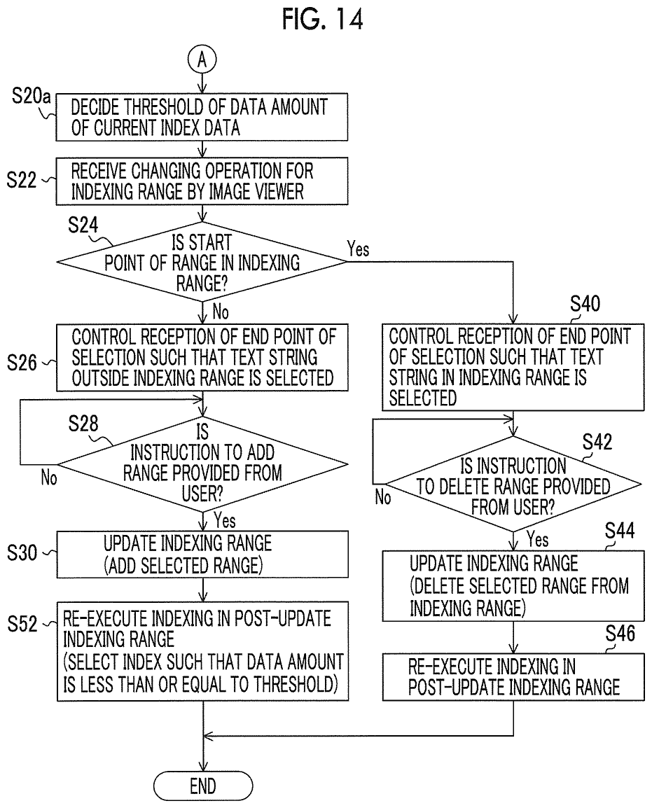

In addition, a process illustrated in FIG. 14 is considered as a modification example of the processes illustrated in FIG. 3 and FIG. 9. In the processing procedure in FIG. 14, steps performing the same process as the steps illustrated in FIG. 9 are designated by the identical reference signs.

In the procedure in FIG. 14, after the indexing range is updated by adding the range added from the user to the original indexing range, the indexing unit 122 re-executes the indexing on the post-update indexing range as a target under control of the application server 130 (S52). In the re-execution, the indexing unit 122 sets the total data amount of the index extracted from the post-update indexing range (that is, the data amount of the index data generated from the range) to be less than or equal to the threshold determined in S20a. That is, the indexing unit 122 calculates the index appropriateness degree of each word or the like included in the post-update indexing range and selects the index in a descending order from a word or the like having the highest appropriateness degree. For example, in a case where the total data amount of the selected index reaches a threshold, further selection of the word or the like as the index is stopped. The function of the application server 130 controlling the indexing unit 122 to perform such a process is one example of a function of a control unit.

Even in the process illustrated in FIG. 14, the amount of the index data generated from the post-update indexing range by the changing operation of the user is reduced to less than or equal to the threshold.

In addition, while the system that performs the indexing on the document is illustrated thus far, the present invention may also be applied to technologies other than the indexing. For example, the method of the present invention may also be applied to a system that generates other types of text strings such as an abstract or a catchphrase of the document representing the feature of the document from the document. That is, in a system that generates a text string such as an abstract or a catchphrase (hereinafter, simply referred to as the “abstract or the like”) showing a feature of a document from a partial range (hereinafter, referred to as a generation range) selected from the document and not from the entire document, the present invention may be applied to a case where the text string showing the feature is updated by causing the user to change the range.

The present invention may be generally applied to a case where, in a situation in which a first text string that includes one or more text strings showing a feature of a document is generated from a first range selected from a content of the document and not from the entire document, a user specifies a second range, and a second text string that represents the feature of the document and includes one or more text strings at least partially different from the first text string is generated from the second range. For example, the first range is the indexing range that is automatically set in the document by the indexing range control unit 110 at the time of registration of the document, the indexing range that is set or changed by any user in the past, a range that is automatically set as a generation range of the abstract or the like by the system generating the abstract or the like, or the generation range of the abstract or the like that is set or changed by any user in the past. In addition, for example, the first text string is the index data, the abstract, or the catchphrase generated from data in the first range of the document. For example, in a case where each index is set as the text string showing the feature of the document, the index data that includes one or more indexes extracted from the first range is one example of the first text string. Accordingly, the indexing unit 122 that generates the index data from the indexing range is one example of a generation unit that generates the first text string from the first range.

In addition, the second range is a range that is specified by the user in the content of the document in a case where one or more text strings that are generated from the first range (that is, the first text string) and show the feature of the document are desired to be changed. The second range typically includes a part that is different from the first range. In the exemplary embodiment of the indexing, with respect to the original indexing range which is one example of the first range, one example of the second range is the post-update indexing range which is the result of the change (that is, the addition or deletion of the range) made to the original indexing range by the user. The second range includes a part overlapping with the first range or a part not overlapping with the first range, or includes both of the parts. In the second range, the part overlapping with the first range is referred to as an “overlapping range”, and the part not overlapping with the first range is referred to as a “non-overlapping range”. For example, in the example of the document image 1000 illustrated in FIG. 11, the post-update indexing range includes both of the highlight display 1002 showing the original indexing range and the highlight display 1004 showing the added range. The part shown by the highlight display 1002 is an example of the overlapping range, and the part shown by the highlight display 1004 is an example of the non-overlapping range. In addition, for example, the second text string is the index data, the abstract, or the catchphrase generated from data in the second range of the document.

In addition, in a typical example, in a case where specifying of the second range is received, the data amount of the second text string generated from the second range or the data amount of the second range is controlled to be less than or equal to a corresponding data capacity thereof. One example of the data capacity is the threshold decided in S20 or S20a.

In addition, in the exemplary embodiment, the function of receiving the changing operation for the indexing range from the user and controlling whether or not to receive the post-update indexing range obtained by the changing operation by controlling the image viewer 204 by the application server 130 is one example of a reception unit and a control unit in the claims.

The document management system 100 described thus far may be implemented by causing a computer to execute a program exhibiting the functions of the element group constituting the document management system 100. For example, as hardware, the computer includes a circuit configuration in which a controller that controls a microprocessor such as a CPU, a memory (temporary storage) such as a random access memory (RAM) and a read only memory (ROM), and a fixed storage device such as a flash memory, a solid state drive (SSD), and a hard disk drive (HDD); various input-output (I/O) interfaces; and a network interface that performs control for connection to a network such as a local area network are connected through, for example, a bus. The program in which the processing content of each function is described is stored in the fixed storage device such as a flash memory through the network or the like and is installed on the computer. By reading the program stored in the fixed storage device into the RAM and executing the program by the microprocessor such as a CPU, a function module group illustrated above is implemented.

In addition, the document management system 100 may be configured in a single computer as described above, or may be configured as a system including plural computers that are communicable with each other.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document processing apparatus comprising:
a reception unit that, in a case where a first text string which is generated from a first range as a partial range of a content of a document and includes one or more text strings showing a feature of the document is present, receives specifying of a second range which is a range in which a second text string which includes one or more text strings at least partially different from the first text string is generated from the content; and
a control unit that controls the reception of the specifying of the second range by the reception unit such that a data amount of the second text string generated from the second range is less than or equal to a data capacity of the second text string determined by a data amount of the first text string or less than or equal to a data capacity which is determined until the second range is specified after decision of the first range in the document.

2. A document processing apparatus comprising:
a reception unit that, in a case where a first text string which is generated from a first range as a partial range of a content of a document and includes one or more text strings showing a feature of the document is present, receives specifying of a second range which is a range in which a second text string which includes one or more text strings at least partially different from the first text string is generated from the content; and
a control unit that controls the reception of the specifying by the reception unit such that a data amount of the second range is less than or equal to a data capacity of the second range determined by a data amount of the first text string or less than or equal to a data capacity which is determined until the second range is specified after decision of the first range in the document.

3. A document processing apparatus comprising:
a reception unit that receives specifying of a second range which is a range in which a second text string which includes one or more text strings at least partially different from a first text string which is generated from a first range as a partial range of a content of a document and includes one or more text strings showing a feature of the document is generated; and
a control unit that controls generation of the second text string from the second range such that a data amount of the second text string generated from the second range received by the reception unit is less than or equal to a data capacity of the second text string determined by a data amount of the first text string or less than or equal to a data capacity which is determined until the second range is specified after decision of the first range in the document.

4. The document processing apparatus according to claim 1,
wherein in a case where the data amount of the second text string exceeds the data capacity of the second text string determined by the data amount of the first text string or the data capacity determined at the time of specifying the second range, the control unit displays a deletion request for requesting designation of a range deleted from the second range.

5. The document processing apparatus according to claim 2,
wherein in a case where the data amount of the second range exceeds the data capacity of the second range determined by the data amount of the first text string or the data capacity determined at the time of specifying the second range, the control unit displays a deletion request for requesting designation of a range deleted from the second range.

6. The document processing apparatus according to claim 4,
wherein the control unit deletes the range designated in response to the display of the deletion request from the second range and, in a case where the data amount of the second text string generated from the second range after the deletion still exceeds the data capacity of the second text string determined by the data amount of the first text string or the data capacity determined at the time of specifying the second range, continues displaying the deletion request.

7. The document processing apparatus according to claim 4,
wherein the control unit deletes the range designated in response to the display of the deletion request from the second range and, in a case where the data amount of the second range after the deletion still exceeds the data capacity of the second range determined by the data amount of the first text string or the data capacity determined at the time of specifying the second range, continues displaying the deletion request.

8. The document processing apparatus according to claim 1,
wherein the control unit displays a part of the first range corresponding to the one or more text strings generated from the first range in a highlighted manner on a screen displaying the content of the document for receiving the specifying by the reception unit.

9. The document processing apparatus according to claim 8,
wherein among one or more text strings that are generated from a range other than the second range in the content of the document and show the feature of the document, the control unit displays a text string that is not included in the one or more text strings generated from the second range in a highlighted manner on the screen.

10. The document processing apparatus according to claim 1,
wherein the control unit displays the one or more text strings included in an overlapping range of the second range that overlaps with the first range to be distinguishable from the one or more text strings generated in a non-overlapping range of the second range that does not overlap with the first range on a screen displaying the content of the document for receiving the specifying by the reception unit.

11. The document processing apparatus according to claim 10,
wherein the control unit performs control such that among one or more text strings that are generated from a range other than the second range in the content of the document and show the feature of the document, a text string not included in the second text string is displayed in a highlighted manner on the screen.

12. The document processing apparatus according to claim 1,
wherein the control unit performs control such that among one or more text strings that are generated from a range other than the first range and show the feature of the document, a text string not included in the first text string is displayed in a highlighted manner on a screen displaying the content of the document for receiving the specifying by the reception unit.

13. The document processing apparatus according to claim 1,
wherein the data capacity changes depending on a total data amount of one or more text strings or the number of documents of the plurality of documents, which is stored in a storage device storing the one or more text strings showing a feature of a document for each of a plurality of the documents.

14. The document processing apparatus according to claim 13,
wherein as the total data amount is increased, the data capacity is decreased.

15. The document processing apparatus according to claim 13,
wherein as the number of documents of the plurality of documents is increased, the data capacity is decreased.

16. The document processing apparatus according to claim 1,
wherein among the one or more text strings included in the second text string generated from the second range, the control unit displays a text string that is not included in the first text string generated from the first range on a screen displaying the content of the document for receiving the specifying by the reception unit.

17. The document processing apparatus according to claim 1,
wherein in a case where the data amount of the second text string is less than the data capacity of the second text string determined by the data amount of the first text string or less than a data capacity determined at the time of specifying the second range, the control unit performs notification that the second range is further spreadable.

18. A non-transitory computer readable medium storing a program causing a computer to function as:
a reception unit that receives specifying of a second range which is a range in which a second text string which includes one or more text strings at least partially different from a first text string which is generated from a first range as a partial range of a content of a document and includes one or more text strings showing a feature of the document is generated; and
a control unit that controls generation of the second text string from the second range such that a data amount of the second text string generated from the second range received by the reception unit is less than or equal to a data capacity of the second text string determined by a data amount of the first text string or less than or equal to a data capacity which is determined until the second range is specified after decision of the first range in the document.
